(19) United States
(12) Patent Application Publication
(10) Pub. No.: US 2005/0265900 A1
(43) Pub. Date: Dec. 1, 2005

(54) Pipetting system with selective pipette tip loading

(76) Inventors: Douglas J. Gard, Indianapolis, IN (US); Chad A. Owens, Greencastle, IN (US)

Correspondence Address: SHELDON & MAK PC, 225 SOUTH LAKE AVENUE, 9TH FLOOR, PASADENA, CA, 91101, US

(21) Appl. No.: 10/856,638

(22) Filed: May 27, 2004

(51) Int. Cl. B01L 3/02

(52) U.S. Cl. 422/100

(57) ABSTRACT

A system for selectively loading pipettes onto a multichannel pipettor using a pipette holder which projects the engagement ends of selected pipettes further away from a support surface compared with a remainder of pipettes retained in the holder.

### BACKGROUND

Scientists routinely transfer liquids between containers when conducting laboratory testing or research, for example to create chemical mixtures or to transfer a biological sample. While early approaches for this liquid transfer used single channel handheld pipettors, multichannel pipettors have become more commonplace with the introduction of multiple-well microplate labware. These multichannel pipettors have helped to speed liquid transfers by simultaneously moving several wells of fluid between labware.

Some microplate-based assays require that a multichannel pipettor address all of the wells of a microplate at the same time for speed and ease of processing. In other assays, however, it may be advantageous or necessary for the pipettor to address only a specific well or selection of wells of a microplate. In order for a pipettor to accommodate both types of assays, pipette heads of different configurations can be installed on the pipettor. Providing multiple pipette heads for a pipetting instrument is costly, however, and it typically requires more physical space to store such additional heads. In addition, using such pipette heads limits a user to performing only those pipetting operations which can be accomplished by the predetermined configurations of the pipette heads.

U.S. Pat. No. 6,506,611 provides an alternative solution to this problem. It describes a pipettor having a pipette head which allows for independent vertical movement of each of a plurality of pipettes mounted to the pipette head. This allows a variety of configurations of pipettes on the pipette head to be designated to address a microplate. However, such a pipettor is mechanically complex and more costly to manufacture compared with conventional multichannel pipette heads.

### SUMMARY

The pipetting systems and methods described herein provide a solution to the problem of selectively addressing specific wells of labware comprising multiple wells or containers with a multichannel pipette head, allowing conventional multichannel pipette heads to be used. In one aspect, the pipetting system includes a movable pipette head, a framework for holding pipettes, and a controller for controlling movement of the pipette head. The pipette head is configured to hold a plurality of pipettes, where each pipette comprises an engagement end and a dispensing end, and is preferably adapted to address a microplate with the pipettes picked up by the pipette head. The framework is configured so that the engagement ends of a selected portion of pipettes placed in the framework project further from a first receiving surface of the framework compared to the engagement ends of a remaining portion of pipettes placed in the framework. In this way the pipette head picks up only the selected portion of pipettes from the framework when it addresses the framework.

In one embodiment of this pipetting system, the framework comprises a second receiving surface for holding the selected portion of pipettes which is elevated with respect to the first receiving surface and which is preferably removably attached to the first receiving surface. The first receiving surface can further comprise first openings for holding the selected portion of pipettes and second openings for holding the remaining portion of pipettes, where the first openings have a smaller circumference compared with the circumference of the second openings. Alternatively, or in addition, the first openings can have inserts placed therein, and the inserts can either reduce the circumference of the first openings or can provide a support surface which is elevated with respect to the second openings. The pipettes in this system can be pipette tips, and the system preferably also includes a source of pipettes which maintains the pipettes in a configuration for being picked up by the pipette head. The controller of the system operates the pipette head so as to transport pipettes from the source of pipettes to the framework and for picking up from the framework only the selected portion of pipettes.

In another aspect, the pipetting system comprises a plurality of pipettes and a holder for holding the pipettes. Each pipette comprises an engagement end, a dispensing end, and a body having first and second sections, the first section being closer to the dispensing end of the pipette than the second section. In addition, each pipette body is preferably tapered, with the circumference of the first section of the pipette body being smaller than the circumference of the second section. The pipette holder has a support surface with a plurality of first openings and second openings, where the first openings are configured for engaging the first section of the pipettes with the engagement ends of the pipettes projecting away from the support. The second openings also hold the pipettes such that the engagement ends of the pipettes project away from the support surface, but are configured for engaging the second sections and not the first sections of the pipettes. Preferably, the circumference of the first openings of the pipette holder is smaller than the circumference of the second openings, so that as a result the engagement ends of the pipettes engaged by the first openings project further away from the support surface than do the pipettes engaged by the second openings. Alternatively, the circumference of the first openings and second openings can be substantially the same, and each of the first openings can include an insert to reduce its circumference. In a further embodiment, the insert is adapted to engage a pipette so that it projects further away from the support surface than pipettes engaged by the first openings.

In the method for pipetting described herein, a plurality of pipettes are preferably first picked up with a pipette head from a source of pipettes that maintains the pipettes in a configuration for pickup by the pipette head. The pipettes are then placed into a support or framework having a first receiving surface for holding the pipettes. The engagement ends of a selected portion of the pipettes placed in the support project further from the first receiving surface than a second portion of the pipettes, and this selected portion of pipettes is loaded onto a pipette head, removed from the support, and used to perform pipetting operations, such as withdrawing fluid from a microplate and dispensing fluid to a microplate. The method preferably also includes picking up the second portion of pipettes from the support with a pipette head after performing a pipetting operation, and then placing the second portion of the pipettes into the support so that a selected portion of such pipettes placed in the support have engagement ends that project further from the first receiving surface than the engagement ends of the remainder of the pipettes. The selected portion of the pipettes in this method can be held in a second receiving surface that is elevated with respect to the first receiving surface, and this second receiving surface is preferably removably attached to the first receiving surface. The second receiving surface is generally removed from the first receiving surface in order to allow a pipette head to pick up the second portion of pipettes retained in the first receiving surface.

### DRAWINGS

These and other features, aspects and advantages of the present invention will become better understood with regard to the following description, appended claims, and accompanying figures where:

FIG. 1 is a sectional view of a pipette attached to the tip mount of a pipettor;

FIG. 2 is a rear perspective view of a mechanical screen placed on an empty pipette tip box, additionally showing a pipette head which is loaded with pipette tips and is positioned over the screen and the pipette tip box;

FIG. 3 is a rear perspective view of a mechanical screen and a pipette tip box as shown in FIG. 2, in which the pipette tip openings of both the screen and the box are filled with pipette tips, additionally showing a pipette head without pipette tips loaded onto it;

FIG. 4 is a rear perspective view of a mechanical screen and a pipette tip box as shown in FIG. 3, in which the pipette tip openings of the box are filled with pipette tips and the pipette tip openings of the screen are empty, additionally showing pipette tips loaded onto a pipette head positioned over the mechanical screen and the pipette tip box. The pipette tips are loaded onto tip mounts of the pipette head in a configuration corresponding to the configuration of the pipette tips in the screen;

FIG. 5 is a top plan view of the mechanical screen shown in FIGS. 2-4;

FIG. 6 is a bottom plan view thereof;

FIG. 7 is a sectional view of the mechanical screen of FIG. 5 along line 7-7; and

FIG. 8 is a rear perspective view of an alternative mechanical device for loading a pipette head with a subset of pipettes.

FIG. 9 is a rear perspective view of a mechanical screen and a pipette tip box as shown in FIG. 4, additionally showing a gripper mechanism engaged with the mechanical screen.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use.

### DETAILED DESCRIPTION

The pipetting systems and methods described herein offer a low cost and flexible approach to loading a multichannel pipette head with a subset of its full capacity of pipettes so that it can address specific wells of, for example, a microplate. As used herein, the term “multichannel pipette head” or simply “pipette head” refers to a pipetting instrument having a plurality of pipettors and/or tip mounts, each of which is adapted to engage a pipette and to draw in and dispense a liquid. The term “tip mount” refers to the portion of a pipette head which is adapted to grip the engagement end of a pipette and cooperate with it in a sealing manner.

With respect to a pipette head, the term “load” refers to the process of placing pipettes onto a pipette head in sealing engagement with the tip mount(s) of the pipette head. The term “shuck” refers to the reverse of this process, namely the process of removing pipettes loaded onto a pipette head.

A “pipetting operation” as used herein refers to the process of withdrawing a material, typically a liquid, from a container with a pipette and then dispensing the liquid into another container. A pipetting operation can involve one or more pipettors and/or tip mounts of a pipette head.

A “controller” is a mechanism that controls the operation of a device, in particular a pipette head, gripper, and/or other component of a pipetting instrument. The controller normally comprises a central processing unit or other processor which controls the operations of the instrument, as well as a module which controls the transfer of data between the processor and the device.

The term “pipette tip box” or simply “tip box” refers to a holder that stores pipettes, in particular pipette tips (described below). A “microplate,” also known as a microtiter plate, refers to a framework containing a series of wells (normally integrally molded with the framework) that are used in laboratory testing and research. Microplates conventionally come in 96-, 384-, and 1536-well sizes. Several ANSI (American National Standards Institute, Inc.) standards (SBS 1-2004, SBS 2-2004, SBS 3-2004, SBS 4-2004) have been established to promote uniformity among microplates.

Pipettes

The term “pipette” used herein refers to a hollow body (i.e., a tube), usually cylindrical and/or conical, which is used to hold and conduct objects or liquids, and which is used in particular to measure and/or transfer precise volumes of a liquid by drawing the liquid into the pipette and then dispensing a measured amount of the liquid into a container. Pipettes are commonly used in laboratory research and testing, and most often are used to transfer liquids in amounts ranging from 50 nanoliters up to about 100 ml, with smaller and larger volumes also possible. For liquid volumes of more than about 2 ml, pipettes are normally provided with volume gradation markings along at least a portion of the length of the pipette. Such pipettes are usually made from transparent glass or plastic, and the liquid volume being drawn into and dispensed from the pipette can be monitored through visual inspection of the fluid meniscus (the liquid-air interface) visible through the pipette.

For volumes smaller than 2 ml, pipettes normally do not include gradation markings, and the volume of a liquid being drawn into and dispensed from the pipette is predetermined by setting a control on a pipettor configured to withdraw and dispense such smaller volumes of liquid. Such small volume pipettes are referred to as “pipette tips,” which can be adapted to withdraw and dispense liquid volumes of 1 ml, 300 μl, 100 μl, 10 μl, 1 μl, or less. The term “pipette” as used herein includes both larger volume pipettes and smaller volume pipette tips. Although pipette tips are used in preferred embodiments of the present invention, the invention is not limited to using pipette tips. Embodiments describing pipettes are to be understood as being applicable to larger volume pipettes as well as to pipette tips unless otherwise indicated in context.

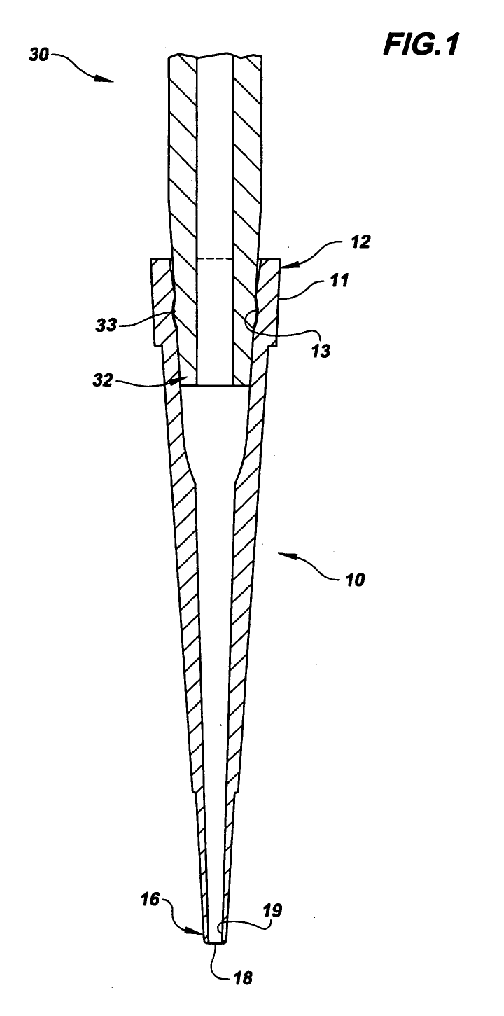

As shown in FIG. 1, the hollow body of a pipette 10 is open at each end, and is generally cylindrical and/or conical along the axis of the tube extending from one open end of the tube to the other. The open ends comprise an engagement end 12 and a dispensing end 16. The engagement end 12 is configured to cooperate with the engagement end 32 of a tip mount 30 of a pipettor so as to be in sealing engagement with the tip mount 30. In the embodiment shown in FIG. 1, the inner surface 13 of the engagement end 12 of the pipette 10 is adapted to be engaged by a pipettor by forming a friction fit with the outer surface 33 of the engagement end 32 of the tip mount 30. The inner surface 13 of the engagement end 12 of the pipette 10 is in this case preferably substantially cylindrical, and is gripped by the outer surface 33 of a substantially cylindrical tip mount 30, though other shapes are also possible for the pipette engagement end 12 and the pipettor tip mount 30. In an alternative embodiment (not shown), a pipette can be configured so that the outer surface 11 of the engagement end 12 of the pipette 10 is tapered and is adapted to form a friction fit with the inner surface of an opening or bore (not shown) of a pipette head, as described in U.S. Pat. No. 6,622,578 (the contents of which are incorporated herein by reference). The pipettes 10 mounted to a pipette head 50 are preferably of approximately the same size and shape, and their engagement ends 12 should form a roughly planar configuration when the pipettes 10 are retained in a tip box 20.

The dispensing end 16 of the body of a pipette 10 is tapered, and is preferably conical (in particular when the engagement end 12 and/or the remainder of the body of the pipette 10 is cylindrical). The dispensing end 16 comprises an opening 18 for dispensing, e.g., liquids. The inner surface 19 of the portion of the pipette body adjacent to the dispensing end opening 18 has a smaller circumference or diameter than the inner surface of a section of the pipette body which is spaced apart (i.e., further away) from the opening 18 of the dispensing end 16. The dispensing end 16 is adapted to withdraw and dispense liquids in a metered fashion. The liquids can comprise aqueous or non-aqueous solutions, emulsions, or any other liquid. In some cases pipettes 10 can be used to transfer powders, gels or other solid materials.

Pipettors

A pipettor is a liquid handler which attaches to the engagement end 12 of a pipette 10 and, when actuated, can draw liquid into the pipette 10 or cause liquid to be dispensed from the dispensing end 16 of the pipette 10. Pipettors preferably are configured to draw a metered amount of liquid into a pipette, in particular when the pipette is a pipette tip, and can preferably be adjusted to allow a range of liquid volumes to be drawn into and dispensed from the pipette 10. Air displacement and positive displacement-type pipettors are commonly used, however air displacement-type pipettors are preferred in the present application because contact between a sample and a surface of the pipettor is avoided.

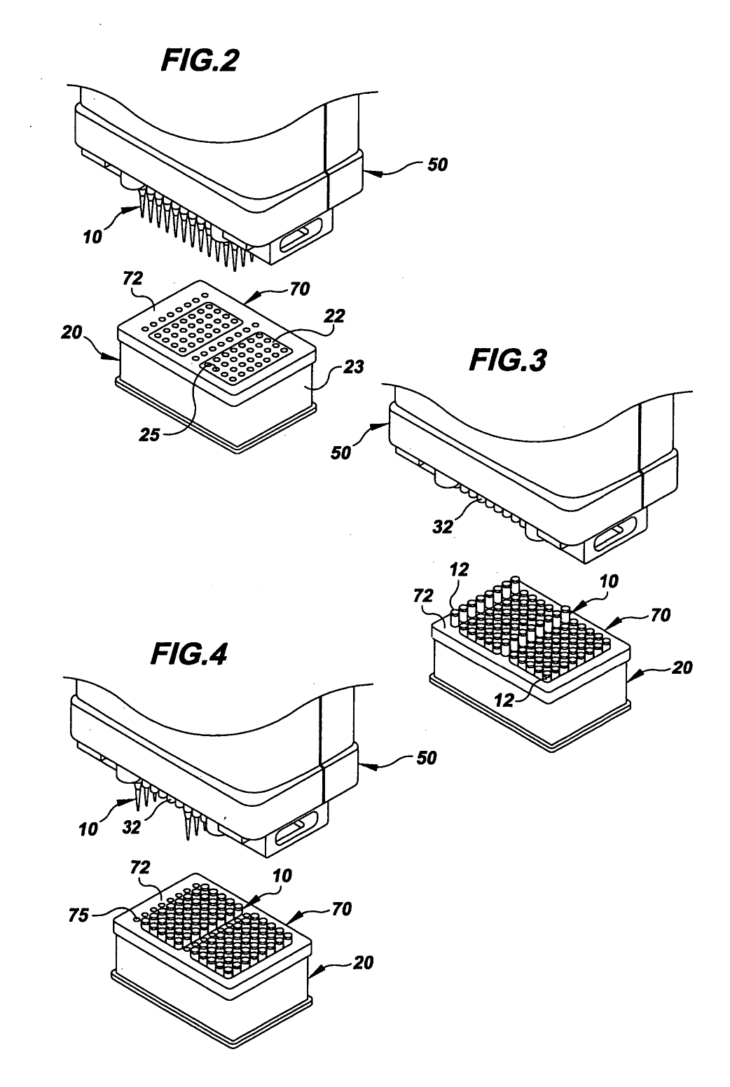

The multichannel pipettors or pipette heads used in the present invention are configured to engage multiple pipettes. Examples of such multichannel pipette heads include those provided with or for the Biomek FX, Biomek NX, Biomek 2000, and Biomek 3000 Laboratory Automation Workstations, all made by Beckman Coulter, Inc. (4300 N. Harbor Boulevard, Fullerton, Calif., U.S.A. 92834). With reference to FIGS. 2-4, the engagement ends 32 of the tip mounts 30 of a pipette head 50 should be substantially in the same plane, so that all of such tip mounts 30 will engage pipettes 10 retained in a tip box 20 when the pipette head 50 is positioned over or adjacent to the tip box 20. To effect the loading of pipettes 10 onto the pipette head 50, the tip mounts 30 are aligned with the engagement ends 12 of the pipettes 10 in the tip box 20, and the pipettes 10 are then loaded onto the tip mounts 30.

The multichannel pipette heads are also preferably automated. An automated pipettor is a robotic version of a handheld pipettor. While the exact configuration and mode of operation can vary between different automated multichannel pipettors, they share several basic elements, including a pipette head, labware holders, a transport mechanism, and liquid handler controls. The pipette head is an adaptation of a handheld pipettor with appropriate controls and drives to perform liquid aspiration and dispensing operations. Labware holders (not shown) allow containers such as microplates or tubes to be positioned for pipette access by pipettes of a pipette head. For example, labware holders can include a recess formed in a horizontal flat surface adapted to retain a labware container such as a microplate. Alternatively, a labware holder can be provided with means for retaining a container such as pins which physically engage such a container. The pipetting instrument is preferably preprogrammed such that the pipette head 50 can locate tip boxes or other pipette holders so positioned by a labware holder and can load and shuck pipettes. Alternatively, the pipetting instrument can be programmed by a user to locate containers present in such labware holders (such programming may also be necessary for preprogrammed units in order to validate the programming).

The transport mechanism of an automated pipettor permits movement of the labware holders and labware containers, the pipette head, or both to accomplish liquid transfer between labware containers. Some automated pipettors have a pipette head which is adapted to move in three dimensions (i.e., along x, y, and z axes) by means of a transport mechanism in order to physically span a collection of labware holders. Such moveable pipette heads are able to perform pipetting operations with labware containers in one area of a pipetting instrument and to load and shuck pipettes in another area. Alternatively or in addition, a transport mechanism can move labware into position to be in communication with or engaged by the pipette head. In one embodiment, the pipette head is configured to move vertically (i.e. along the z-axis) while labware holders are moved horizontally along the x- and y-axes in order to perform pipetting operations.

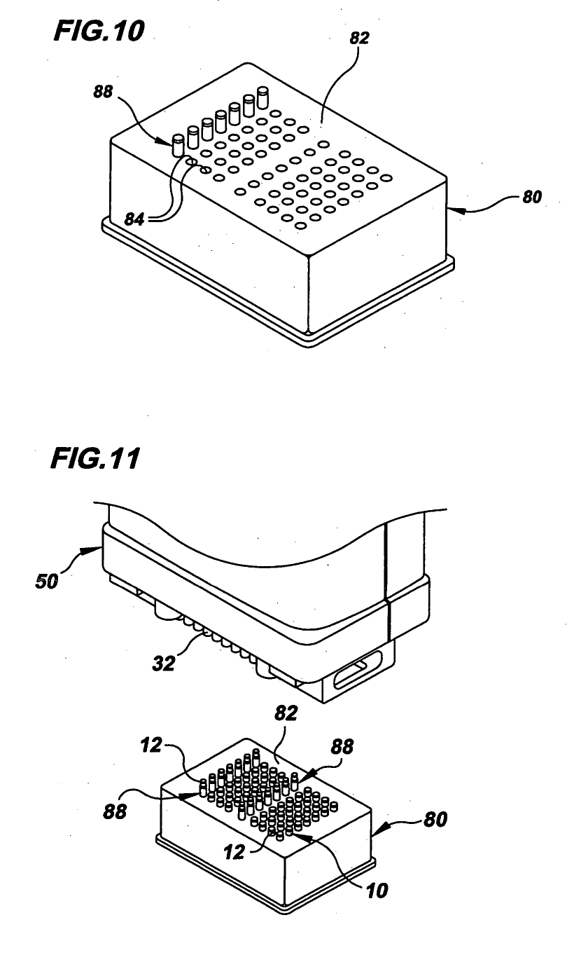

Another feature of some pipetting instruments is a gripping mechanism 100 for use in moving labware. A gripper 100 can be attached to the same mechanical arm or other transport mechanism used to move the pipette head, or can reside on another transport mechanism. A simple gripper can consist of two or more gripping surfaces, such as pincers, which can be moved toward or away from one another. The gripping surfaces engage items to be moved and are preferably adapted to prevent slippage of such items once they are in contact with the gripper. One such gripper 100, illustrated in FIG. 9, includes arms 104 attached to the pipette head 50 which can be moved vertically downward (i.e., away from the engagement ends 32 of the tip mounts 30 of the pipette head 50) in order to engage an item to be moved. Although four gripping members 102 are illustrated in the gripper 100 shown in FIG. 9, other gripper configurations are also possible, such as the use of two or three gripping members, or the use of a different mechanism for moving a mechanical screen 70 or other labware.

A controller controls movement of the pipette head. Other pipettor controls typically include software designed to allow the user to specify the sequence of operations such as dispenses and aspirations. Further, the controls can enable the use of extra features such as a labware gripper or data tracking.

Mechanical Screen

Microplate-based assays at times require that a pipette head address all the wells of a microplate at the same time for speed and ease of processing, but at other times an assay may require that the pipette head address only a specific well or subset of wells. Both conditions can be accommodated with one pipette head through the use of a mechanical device such as a mechanical screen which retains the engagement ends of selected pipettes held by the device further from a particular surface than the engagement ends of other pipettes, thereby allowing a pipette head to engage the selected pipettes and not the others.

Pipettes 10 are conventionally stored in a tip box 20 (see FIGS. 2-4). A tip box 20 retains pipettes 10 such that the engagement ends 12 of the pipettes 10 extend away from a support surface 22 of the tip box 20, and preferably retains pipettes 10 such that the engagement ends 12 form a roughly planar configuration. In this way the engagement ends 12 of pipettes 10 retained in the tip box 20 are available to engage the tip mounts 30 of a pipette head 50 when the engagements ends 32 of the tip mounts 30 are in a roughly planar configuration. The tip box 20 thus maintains pipettes 10 in a configuration for being picked up by the pipette head 50.

In one embodiment, a mechanical screen 70 is configured for engagement with a tip box 20. For example, in the embodiment shown in FIGS. 2-7, the mechanical screen 70 comprises a support structure or framework 71 adapted to be placed on and removably attached to the surface of a tip box 20. The framework 71 has a lower surface 73 (FIGS. 6 and 7) configured to contact the support surface 22 of a tip box 20. Alternatively, the framework 71 can cooperate with another portion of the tip box 20 or with a labware holder of an automated pipettor. The mechanical screen 70 includes a support or receiving surface 72 which retains pipettes 10 in openings 75 such that the engagement ends 12 of a selected portion of pipettes 10 placed in the mechanical screen 70 project further from the support surface 22 of the tip box 20 than the engagement ends 12 of a remaining portion of pipettes 10 retained in openings 25 in the tip box 20 (best seen in FIG. 3). In this embodiment the engagement ends 12 are retained further from the tip box support surface 22 by means of a mechanical screen support surface 72 which is elevated with respect to tip box support surface 22. In this context the term “elevated” with respect to support surface 22 refers to a position or plane (corresponding to the surface of the support surface 72) that is spaced away from a plane of the tip box support surface 22. Since the tip box 20 is generally placed with the support surface 22 facing generally upward (though this is not mandatory), when mechanical screen support surface 72 is spaced away from tip box support surface 22 it can be said to be elevated with respect to the tip box support surface 22. The tip box support surface 22 and the mechanical screen support surface 72 are preferably substantially planar and also parallel to one another.

The mechanical screen 70 is adapted to be removably attached to the tip box 20, so that it can be removed from one tip box and placed on another, as described in more detail below. Although the embodiment of the mechanical screen 70 shown in FIGS. 2-6 has a support surface 72 which is adapted to retain two rows of pipette tips, the support surface 72 can be designed to hold other configurations of pipette tips, depending on which subset of labware containers or wells needs to be addressed by a pipette head 50 in a particular assay. For example, the mechanical screen 70 can be configured to retain a single row or only a partial row of pipettes 10, or can retain individual pipettes 10 or groups of pipettes 10.

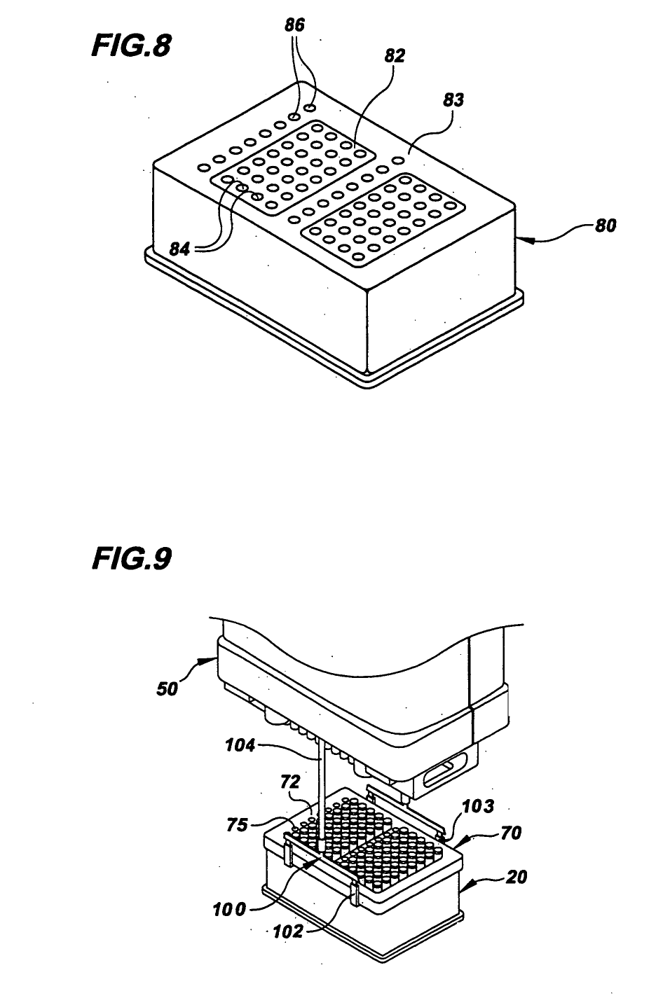

In another embodiment, shown in FIG. 8, the mechanical device for enabling a pipette head to address only a subset of labware containers or wells can be a holder 80 for holding pipettes 10, the holder 80 having a first support surface 82 with a plurality of first openings 84 and a second support surface 83 having second openings 86 configured to retain pipettes 10 with the engagement ends 12 of the pipettes 10 projecting away from the first support surface 82. The engagement ends 12 of the pipettes 10 engaged by the second openings 86 project further away from the first support surface 82 than do the pipettes 10 engaged by the first openings 84. The engagement ends 12 of the pipettes 10 engaged by the second openings 86 are preferably coplanar so that they can be picked up by a pipette head 50. In this embodiment the second support surface 83 is elevated with respect to the first support surface 82. The second support surface 83 can be removably attached to the holder 80, in which case the second support surface 83 would form a mechanical screen 70 as described above.

In an alternative embodiment of the holder 80 (not shown), the first and second support surfaces 82 and 83 are preferably substantially coplanar. In this embodiment the first openings 84 and/or the wall(s) projecting downward from the first openings 84 (i.e. toward the dispensing end 16 of a pipette 10 when a pipette 10 is retained in one of the first openings 84) are adapted to engage a portion of a pipette 10 which is closer to the engagement end 12 of the pipette 10 than the portion which is engaged by the second openings 86. Since the body of a pipette is tapered, so that the circumference of a first section is smaller than the circumference of a second section, this can be accomplished by providing first openings 84 of a larger circumference than the circumference of the second openings 86, so that the first openings 84 engage the second (larger circumference) section of a pipette 10 while the second openings 86 engage the first (smaller circumference) portion of a pipette 10. This results in the engagement ends 12 of the pipettes 10 engaged by the second openings 86 projecting further from the coplanar first and second support surfaces 82 and 83 than engagement ends 12 of the pipettes 10 engaged by the first openings 84.

In another alternative embodiment (not shown), the first and second support surfaces 82 and 83 are preferably substantially coplanar and the circumference of the first openings 84 is substantially the same as the circumference of the second openings 86. In this embodiment the engagement ends 12 of pipettes in the second openings 86 project further away from the support surfaces 82 and 83 than the engagement ends 12 of pipettes 10 retained in the first openings 84 by means of inserts in the second openings 86. The inserts can be placed in each of the second openings 86, or alternatively an insert can span a plurality of second openings, and can provide support surfaces for pipettes corresponding to each of the plurality of second openings 86. Such inserts can act to reduce the circumference of the second openings, or alternatively can provide a support surface for retaining one or more pipettes 10 which is elevated with respect to the first support surface 82, and which maintains the engagement ends 12 of the pipettes 10 at a distance further away from the first support surface 82 than the engagement ends 12 of pipettes 10 retained in the first openings 84.

Selective Tip Loading

A mechanical screen such as that shown in FIGS. 2-7 can be used to load a multichannel pipette head with a subset of its full capacity of tips as follows. The mechanical screen 70 is first placed on an empty tip box 20 either manually or by mechanical means such as with a gripper 100 (FIG. 9). A source of pipettes (not shown) which maintains pipettes 10 in a manner allowing them to be picked up by a pipette head 50, preferably a first tip box 20 filled with pipettes 10, is provided. The second (empty) tip box 20 is preferably of substantially the same size and shape as the first tip box (at least with respect to the upper surface 22 which retains the pipettes 10). The tip boxes should be in an area addressable by the multichannel pipette head 50, i.e. if an automated multichannel pipette head 50 is employed the tip boxes should be within the mechanical range of the pipette head 50 for picking up and shucking pipettes.

The pipette head 50 is next loaded with tips from the first (full) tip box 20. This is accomplished by positioning the pipette head 50 (using a controller of the pipetting instrument) over the first tip box 20 such that the engagement end 32 of each tip mount 30 of the pipette head 50 is aligned with the engagement end 12 of a pipette 10 retained in the first tip box 20. The full tip box 20 most commonly will be supported on a bench or on a labware holder having a surface that's roughly parallel to the floor of the room in which it is located, so that the engagement ends 12 of the pipettes 10 are directed upward and the pipette head 50 is aligned directly over the full tip box 20. Loading of the pipettes 10 onto the pipette head 50 is then accomplished by lowering the pipette head 50 such that the engagement ends 32 of the tip mounts 30 contact the engagement ends 12 of the pipettes 10 and form a friction fit with the pipettes 10. The pipette head 50 then withdraws the pipettes 10 from the tip box 20 by moving in the reverse direction, i.e. by moving upward, thereby picking up the pipettes 10. It is to be understood that the tip box 20 can alternatively be moved instead of or in addition to moving the pipette head 50 in order to load the pipettes 10 or to accomplish the following steps.

The pipette head 50 is then directed to the second tip box 20 onto which the mechanical screen 70 has been placed (see FIG. 2). The pipette head 50 is positioned over the tip box 20 and the mechanical screen 70 such that the dispensing ends 16 of the pipettes 10 are aligned with the openings 25 in the tip box 20 and with the openings 75 in the mechanical screen 70, and preferably so that the dispensing ends 16 of the pipettes 10 are located within the openings 25 and 75. The pipette head 50 then shucks the pipettes 10 into the openings 25 and 75, resulting in the pipettes 10 being retained on the support surface 22 of the tip box 20 and on the support surface 72 of the mechanical screen 70 as shown in FIG. 3. As can be seen in FIG. 3, the engagement ends 12 of the pipettes 10 retained in the mechanical screen 70 project further from the support surface 22 of the tip box 20 than do the engagement ends 12 of the pipettes 10 retained by the support surface 22 itself.

The pipette head 50 is then advanced downward in order to load the pipettes 10 which are retained in the support surface 72 of the mechanical screen 70. The pipette head can be programmed to advance a predetermined distance toward the pipettes 10 in order to engage them, or alternatively can be configured to cease movement toward the pipettes 10 in response to resistance, e.g. the pipette head 50 can discontinue advancing when its movement slows or stops while power to the transport mechanism of the pipette head 50 remains the same or increases. The engagement ends 12 of the pipettes 10 retained in the mechanical screen 70 are engaged by the engagement ends 32 of the tip mounts 30 of the pipette head 50, while the engagement ends 12 of the pipettes 10 retained in the tip box 20 are not engaged by tip mounts 30 of the pipette head 50. This is because the engagement ends 12 of the pipettes 10 retained in the mechanical screen 70 are elevated with respect to the engagement ends 12 of the pipettes 10 retained in the tip box 20, such that the pipette head tip mounts 30 reach and physically engage the engagement ends 12 of the pipettes 10 retained in the mechanical screen 70 before coming into contact with the pipettes 10 retained in the tip box 20. The pipette head 50 is thereby selectively loaded with the pipettes 10 retained in the mechanical screen 70. After loading the pipettes 10 retained in the support surface 72 of the mechanical screen 70, the pipette head 50 withdraws these pipettes 10 from the mechanical screen 70 and is ready to perform pipetting operations with these pipettes 10, as shown in FIG. 4.

In order to load a second portion of pipettes 10, a gripper mechanism 100 can then engage the mechanical screen 70 on the second tip box 20 and lift the mechanical screen 70 to remove it from the second tip box 20. As shown in FIG. 9, the gripper 100 advances gripping surfaces 103 of gripping members 102 toward the outer surface 74 of the mechanical screen 70 until they contacts and engage the outer surface 74. The gripper 100 is then preferably moved vertically upward (away from the surface 22 of the tip box 20) by means of arms 104 in order to remove the mechanical screen 70 from the tip box 20.

The mechanical screen 70 can then be placed on the first tip box 20 which was originally full of pipettes 10 but which is at this point empty. The pipette head 50 then loads pipettes 10 from the second tip box 20 and is positioned over the first tip box 20 and the mechanical screen 70, and shucks pipettes 10 into the mechanical screen 70 such that the openings 75 in the mechanical screen 70 are filled, and such that some of the openings 25 in the first tip box 20 are also filled. If two rows of pipettes 10 have already been removed from the second tip box 20, for example as illustrated in FIGS. 2-4, the pipette head 50 will then contain two rows of tip mounts 30 which do not have pipettes 10 loaded on them and two rows of pipettes 10 in the first tip box 20 will be empty. The pipettes 10 loaded in the mechanical screen 70 are at this point in a configuration for pickup by the pipette head 50, and a further pipetting operation can be performed with them. The foregoing steps can be repeated until all the pipettes 10 from the first tip box 20 are used.

In some embodiments, an alternative procedure can be used to load a second portion of pipettes 10. If the engagement ends 12 of pipettes 10 retained in the tip box 20 (or in the support surface 82 of the embodiment shown in FIG. 8) are configured to extend beyond the plane occupied by the mechanical screen 70 (or the support surface 83, as the case may be), the tip mounts 30 of the pipette head 50 can be adapted to engage the second portion of pipettes 10 without removing the mechanical screen 70 or otherwise removing the pipettes 10. In this embodiment, after performing a pipetting operation as described above, the pipette head 50 loads the pipettes 10 directly, without removing the mechanical screen 70, after which the process continues as described above.

### EXAMPLE 1

### Mechanical Screen

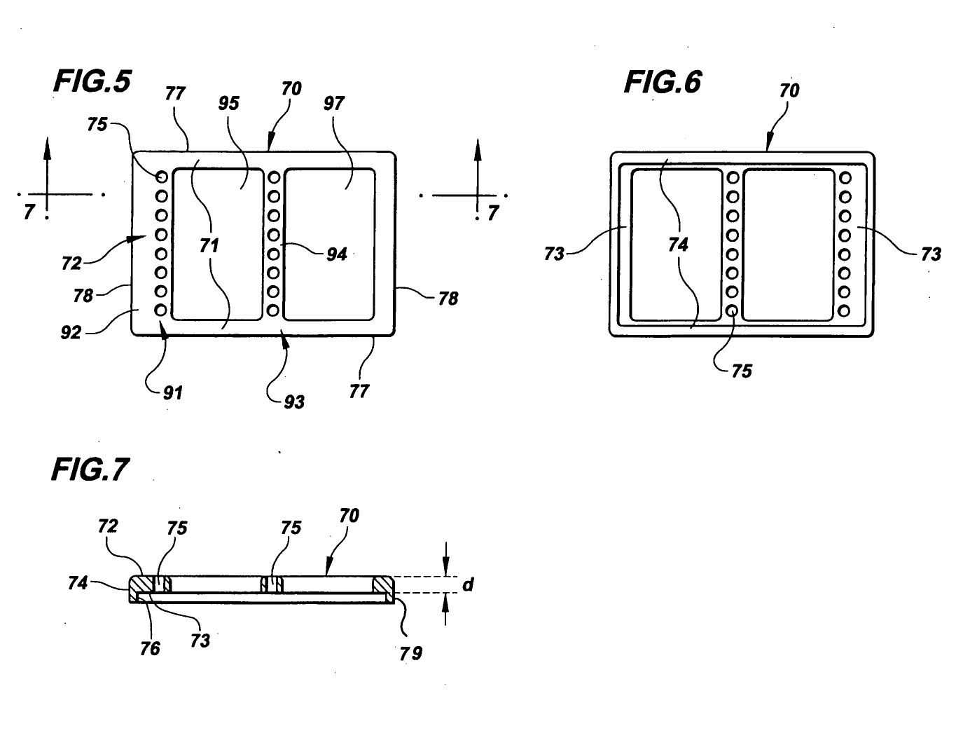

A mechanical screen as shown in FIGS. 5-7 was formed from aluminum and provided with a corrosion resistant coating. The mechanical screen 70 included a framework 71 configured to fit on top of a tip box 20. The framework 71 included an upper receiving surface 72 for receiving and supporting pipettes 10 and a lower surface 73 for contacting the upper surface of the tip box 20. The framework 71 further included two roughly parallel longer sides 77 approximately 5 inches in length and two roughly parallel shorter sides 78 approximately 3.5 inches in length. A first row 91 of openings 75 roughly parallel to the shorter sides 78 and was formed in a first portion 92 of the receiving surface 72 adjacent one of the shorter sides 78. The openings 75 extended through the receiving surface 72 to the lower surface 73 and had substantially the same circumference. A second row 93 of openings 75 was formed in a second portion 94 of the receiving surface 72. The second portion 94 of the receiving surface 72 extended between the longer sides 77 and served to divide a first opening 95 for providing access to the surface of a pipette box 20 from a second opening 97.

A lip 79 was formed in the framework 71 extending beyond the lower surface 73 of the mechanical screen 70 and extending around the circumference of the framework 71. The inner surface 76 of the lip 79 was configured to contact a vertical side wall 23 of a tip box 20, and to cooperate with the lower surface 73 to grip a tip box 20 and stabilize the mechanical screen 70 when it was placed on top of a tip box 20. The receiving surface 72 was elevated and spaced apart from the lower surface 73 (and hence from the upper surface 22 of a tip box 20 when lower surface 73 was in contact with the upper surface 22 of the tip box 20) by a distance of approximately 0.2 inches (shown as distance “d” in FIG. 7).

### EXAMPLE 2

### Selective Tip Loading

The mechanical screen 70 of Example 1 was used to selectively load pipettes 10 onto a pipette head as follows. The pipette head 50 of a Biomek FX instrument having a capacity of 96 pipettes (for use with 96-well microplates) was positioned over a first tip box 20 having a 96 tip capacity that was filled with pipettes 10. The first tip box 20 was positioned on a labware holder of the instrument. The pipette head 50 was lowered toward the first tip box 20 until each of the tip mounts 30 engaged the engagement ends 12 of the pipettes 10 in the first tip box 20 so as to form a friction fit with them. The pipette head 50 was then raised, thereby picking up all of the pipettes 10 and removing them from the tip box 20.

Prior to this the mechanical screen 70 was placed on a second tip box 20 positioned on another labware holder of the Biomek FX instrument. This tip box also had a 96 tip capacity but was empty. After removing pipettes 10 from the first tip box 20, the pipette head 50 was positioned over the second tip box 20 (as illustrated in FIG. 2) so that each of the pipettes 10 loaded onto the pipette head 50 was aligned with either an opening 25 in the tip box 20 or with an opening 75 in the mechanical screen 70. The pipette head 50 was then lowered toward the second tip box 20 and the dispensing ends 16 of the pipettes 10 were shucked into the openings 25 and 75. The pipettes 10 were thereby placed in each of the openings 25 in the second tip box 20 and in each of the openings 75 of the mechanical screen 70. The engagement ends 12 of the pipettes 10 in the openings 75 in the mechanical screen 70 projected approximately 0.2 inches further from the tip box surface 22 than the engagement ends 12 of the pipettes 10 loaded into the openings 25 of the second tip box 20.

The pipette head 50 was then lowered so as to engage the pipettes 10 retained in the mechanical screen 70. The pipette head 50 ceased descending after loading the pipettes 10 in the mechanical screen 70 so that the tip mounts 30 positioned over the pipettes 10 in the second tip box 20 did not engage these pipettes 10. The pipette head 50 was then raised, thereby picking up the pipettes 10 loaded into the mechanical screen 70 and removing them from the mechanical screen 70, leaving the remaining pipettes 10 in the second tip box 20.

The pipette head 50 was then used to perform pipetting operations with the pipettes 10 loaded onto it. The tips were lowered into corresponding wells of a 96-well microplate, and a predetermined amount of a liquid sample was drawn into each of the pipettes 10. The pipette head 50 was then raised and moved to a different 96-well microplate and the pipettes 10 were positioned over selected wells of the microplate. The pipette head 50 was then lowered to a position over the microplate such that the loaded pipettes 10 were able to dispense the liquid sample into the selected wells of the microplate. After the liquid sample was dispensed from the pipettes 10, the pipette head 50 was raised and moved to position it over a waste container, and the pipettes 10 on the pipette head 50 were then discarded into the waste container.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference to their entirety.

1. A pipetting system comprising:
(a) a plurality of pipettes of approximately the same size, wherein each of the pipettes comprises an engagement end and a dispensing end;
(b) a movable pipette head for holding the pipettes;
(c) a framework having a first receiving surface for holding the pipettes, wherein the framework is adapted so that the engagement ends of a selected portion of the pipettes placed in the framework project further from the first receiving surface than the engagement ends of a remaining portion of the pipettes placed in the framework; and
(d) a controller for controlling movement of the pipette head so that the pipette head picks up only the selected portion of the pipettes from the framework.

2. The system of claim 1, wherein the framework comprises a second receiving surface for holding the selected portion of pipettes, the second receiving surface being elevated with respect to the first receiving surface.

3. The system of claim 2, wherein the second receiving surface is removably attached to the first receiving surface.

4. The system of claim 1, wherein the first receiving surface comprises first openings for holding the selected portion of pipettes and second openings for holding the remaining portion of pipettes, and wherein the circumference of the first openings is smaller than the circumference of the second openings.

5. The system of claim 1, wherein the first receiving surface comprises first openings for holding the selected portion of pipettes and second openings for holding the remaining portion of pipettes, and wherein the framework comprises inserts in the first openings.

6. The system of claim 5, wherein the inserts reduce the circumference of the first openings.

7. The system of claim 5, wherein the inserts provide a support surface which is elevated with respect to the second openings.

8. (canceled)

9. The system of claim 1, wherein the pipettes are pipette tips.

10. A pipetting system comprising:
(a) a plurality of pipettes of approximately the same size, wherein each pipette comprises an engagement end and a dispensing end;
(b) a movable pipette head for holding the pipettes;
(c) a source of pipettes maintaining the pipettes in a configuration for being picked up by the pipette head;
(d) a framework having a first receiving surface for holding pipettes, wherein the engagement ends of a selected portion of the pipettes placed in the framework project further from the first receiving surface than the engagement ends of a remaining portion of the pipettes placed in the framework; and
(e) a controller for controlling movement of the pipette head for transporting pipettes from the source to the framework and for picking up from the framework only the selected portion of pipettes.

11. A method for pipetting comprising the steps of:
(a) placing a plurality of pipettes of approximately the same size in a support having a first receiving surface for holding pipettes, wherein each pipette comprises an engagement end and a dispensing end, and wherein a selected portion of the pipettes placed in the support have engagement ends that project further from the first receiving surface than a second portion of the pipettes;
(b) removing only the selected portion of the pipettes from the support; and
(c) after step (b), performing pipetting operations with at least some of the removed pipettes.

12. The method of claim 11, wherein step (b) comprises loading the pipettes from the support onto a pipette head.

13. The method of claim 11, wherein step (c) comprises withdrawing fluid from a microplate.

14. The method of claim 11, wherein step (c) comprises dispensing fluid to a microplate.

15. A method for pipetting comprising the steps of:
(a) picking up a plurality of pipettes of approximately the same size with a pipette head from a source of pipettes that maintains the pipettes in a configuration for pickup by the pipette head, wherein each pipette comprises an engagement end and a liquid dispensing end;
(b) placing the picked up pipettes in a framework having a first receiving surface for holding pipettes, wherein a selected portion of the pipettes placed in the framework have engagement ends that project further from the receiving surface than the engagement ends of a second portion of pipettes;
(c) picking up only the selected portion of the pipettes from the framework with the pipette head;
(d) after step (c), performing pipetting operations with at least some of the pipettes in the pipette head;
(e) after step (d), removing the pipettes from the pipette head;
(f) after step (e), picking up the second portion of the pipettes from the framework with a pipette head; and
(g) after step (f), placing the picked up second portion of the pipettes in the framework so that a selected portion of such pipettes placed in the framework have engagement ends that project further from the receiving surface than the engagement ends of the remainder of the pipettes.

16. The method of claim 15, wherein the framework comprises a second receiving surface for holding the selected portion of pipettes, the second receiving surface being elevated with respect to the first receiving surface, and wherein the second receiving surface is removably attached to the first receiving surface, comprising the step of removing the second receiving surface from the first receiving surface after step (c).

17. A pipetting system comprising:
(a) a plurality of pipettes of approximately the same size, each pipette comprising an engagement end, a dispensing end, and a body having first and second sections, the first section being closer to the dispensing end than the second section; and
(b) a holder for holding the pipettes, the holder having a support surface with a plurality of first openings and second openings,
wherein the first openings are configured for engaging the first section of the pipettes with the engagement ends of the pipettes projecting away from the support, and
wherein the second openings are configured for engaging the second sections but not the first sections of the pipettes with the engagement ends of the pipettes projecting away from the support surface, whereby the engagement ends of the pipettes engaged by the first openings project further away from the support surface than do the pipettes engaged by the second openings.

18. The pipetting system of claim 17, wherein each pipette body is tapered with the circumference of the first section being smaller than the circumference of the second section, and the circumference of the first openings is smaller than the circumference of the second openings.

19. The pipetting system of claim 17, wherein each pipette body is tapered with the circumference of the first section being smaller than the circumference of the second section, the circumference of the first openings being substantially the same as the circumference of the second openings, and wherein the system comprises an insert in each of the first openings to reduce their circumference.

20. The pipetting system of claim 17, wherein each pipette body is tapered with the circumference of the first section being smaller than the circumference of the second section, the circumference of the first openings being substantially the same as the circumference of the second openings, and wherein the system comprises an insert in each of the first openings, wherein the insert is adapted to engage a pipette so that it projects further away from the support surface than pipettes engaged by the first openings.
